(19) United States
(12) Patent Application Publication
(10) Pub. No.: US 2008/0208731 A1
(43) Pub. Date: Aug. 28, 2008

(54) Methods and computer program products for auctioning on-line advertisements based on Internet search term query origination location

(75) Inventor: John Ruckart, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/712,137

(22) Filed: Feb. 28, 2007

(51) Int. Cl. G06Q 30/00; G06F 17/30

(52) U.S. Cl. 705/37; 707/3; 707/E17.017

(57) ABSTRACT

In some methods for auctioning on-line advertisement placement services, an on-line advertisement placement service is offered based on at least one search term and based on at least one geographic area where the at least one search term will originate. Monetary bids are received from entities responsive to the offer of on-line advertisement placement service. In response to the monetary bids, the on-line advertisement placement service for the at least one search term originating from the at least one geographic area is awarded to a selected one or more of the entities.

### FIELD OF THE INVENTION

The present invention relates to searching content of Internet websites and, more particularly, to auctioning on-line advertisement placement services that are responsive to Internet search term queries.

### BACKGROUND OF THE INVENTION

The Internet has become a worldwide packet switched network for communicating not just data, such as email and pictures, but also for providing real-time bi-directional voice communications. The Internet includes a worldwide web (WWW) of client-server based facilities on which Web pages and files can reside at websites, as well as clients (Web browsers) that can interface users with the client-server facilities. The topology of the WWW can be described as a network of networks, with providers of network service called Network Service Providers. Servers that provide application-layer services may be described as Application Service Providers. Sometimes a single service provider does both functions within a single business.

Internet search engines have evolved that enable users to search the Internet for website content. In a web-based search on an Internet search engine, a user enters a search term including one or more keywords, which the search engine then uses to generate a listing of web pages that the user may access via hyperlinks embedded within the listing of web pages.

Internet search engines can generate revenue by selling on-line advertising to website promoters (e.g., business entities having customer websites). The on-line advertisements can include banner advertising and placement of website promoter names among the Internet search result listing of web pages. In banner advertising, website promoters (advertisement sponsors) seeking to promote and increase their web exposure often purchase space on the pages of popular Internet search engine websites. The advertisement sponsors usually fill this space with a colorful graphic, known as a banner, advertising their own website. The banner may act a hyperlink that a visitor may click-on to access the sponsor's website. Advertisement sponsors may alternatively or additionally purchase the right to control placement of the sponsor's website among the Internet search result listing of web pages so that the sponsor's website is prominently presented to users who conduct searches using terms that are relevant to the content of their website. This is often referred to as a sponsored link. Like traditional advertising, such advertising on Internet search engines is typically priced based on the location and size of the advertisement, and can be further priced based on how many times users select a hyperlink associated with the advertisement to click-through the advertisement to the advertisement sponsor's website.

Some Internet search engines carry out an auction for on-line advertisements, such as by auctioning certain search terms to advertisement sponsors. For example, an entity that provides hotel services may make a monetary bid on the search term “hotel”. If that entity's bid is successful (e.g., the highest bid), the Internet search engine will then be configured to respond to a user's search term query containing the term “hotel” by displaying to the user a banner advertisement for the sponsor and/or by listing the sponsor's website among the search results returned to the user (e.g., at the top of the list of search results).

### SUMMARY OF THE INVENTION

Methods and computer program products are provided for auctioning on-line advertisement placement services. Some embodiments of the present invention associate on-line advertisement placement services with one or more terms that can be received in an Internet search term query and with the geographic location where the Internet search term query can originate.

Some methods of auctioning on-line advertisement placement services include: (a) offering an on-line advertisement placement service based on at least one search term and based on at least one geographic area where the at least one search term will originate; (b) receiving monetary bids from entities responsive to the offer of on-line advertisement placement service; and (c) in response to the monetary bids, awarding the on-line advertisement placement service for the at least one search term originating from the at least one geographic area to a selected one or more of the entities.

Some other methods of auctioning online advertisement placement services include: (a) displaying input fields on a plurality of remote computers; (b) receiving information from bidders at the remote computers in response to the input fields that includes at least one search term, a corresponding at least one geographic area where the at least one search term will originate, and a corresponding monetary bid; and (c) communicating the information from the remote computers to an Internet search engine.

Yet some other methods of auctioning online advertisement placement services include: (a) receiving at an Internet search engine, from a user via a network, a search term query to be searched using the Internet search engine and location information that is indicative of a least one geographic area where the at least one search term originated; (b) selecting an advertisement in response to the search term query and the geographic area where the at least one search term originated; and (c) transmitting via the network the selected advertisement to the user.

Other methods, computer program products, and/or related systems according to embodiments of the invention will be or become apparent to one with skill in the art upon review of the following drawings and detailed description. It is intended that all such additional methods, computer program products, and/or related systems be included within this description, be within the scope of the present invention, and be protected by the accompanying claims.

### BRIEF DESCRIPTION OF THE DRAWINGS

FIG. 1 is a block diagram that illustrates geographic areas and associated search terms which are being auctioned for on-line advertisement placement services in accordance with some embodiments of the present invention.

FIG. 2 is a table that illustrates a search term bid form generated by an Internet search engine to auction on-line advertisement placement services in accordance with some embodiments of the present invention.

FIG. 3 is a flow chart that illustrates operations for auctioning on-line advertisement placement services for Internet search terms and associated geographic areas where the Internet search term queries will originate in accordance with some embodiments of the present invention.

FIG. 4 is a block diagram of an Internet search engine that is configured in accordance with some embodiments of the present invention.

FIG. 5 is a block diagram of a system that is configured to carry out auctioning of on-line advertisement placement services and to display advertisements in response to Internet search term queries and the geographic area where the queries originated in accordance with some embodiments of the present invention.

FIG. 6 is a message flow diagram that illustrates operations for displaying advertisements in response to Internet search term queries and in response to geographic areas where the queries originated in accordance with some embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another elements, there are no intervening elements present. As used herein the term “and/or” includes any and all combinations of one or more of the associated listed items and may be abbreviated as “/”.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain and/or store the program for use by or in connection with an instruction execution system, apparatus, or device.

The computer-usable or computer-readable medium may be, for example but not limited to, an electronic, magnetic, optical, electromagnetic, infrared, or semiconductor system, apparatus, and/or device. More specific examples (a nonexhaustive list) of the computer-readable medium include the following: a portable computer diskette, a random access memory (RAM), a read-only memory (ROM), an erasable programmable read-only memory (EPROM or Flash memory), and a compact disc read-only memory (CD-ROM).

In accordance with some embodiments of the present invention, on-line advertisements are auctioned based on search terms and the geographic areas from which the search terms will originate. Thus, a website promoter may bid for certain search terms that are generated by users who are located in certain geographic areas. The website promoter may thereby target not only search terms that appear relevant to the content of the website promoter's website, but may also target geographic areas that are more relevant to that content, such as geographic areas that are local to the promoter's businesses and/or geographic areas that contain targeted types of customers. The geographic areas from which the search terms originate may be auctioned based on, for example, a state, a postal ZIP code, a city, a town, a coverage area of one or more cellular base station communication towers, and/or other defined geographic boundaries.

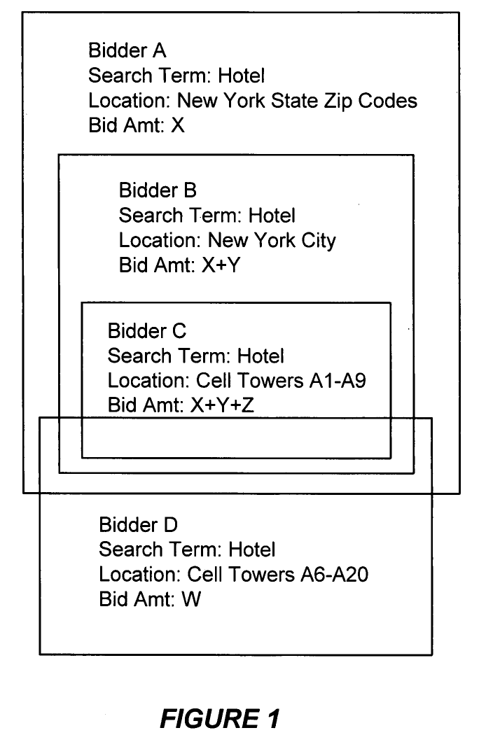

Embodiments of the present invention will now be discussed with respect to the figures. FIG. 1 is a block diagram that illustrates geographic areas and associated search terms which are being auctioned for on-line advertisement services. Referring to FIG. 1, Bidder A has bid a monetary amount “X” for the search term “Hotel” which will originate in search term queries from a geographic area that corresponds to the postal ZIP codes for New York state. Another website promoter “Bidder B” has bid a monetary amount “X+Y” for the search term “Hotel” which will originate in search term queries from a geographic area corresponding to New York city. Another website promoter “Bidder C” has been a monetary amount “X+Y+Z” for the search term “Hotel” originating from a geographic area corresponding to cellular base station communication towers numbered A1-A9, which may correspond to a region of Manhattan. Another website promoter “Bidder D” has been a monetary amount “W” for the search term “Hotel” originating from a geographic area corresponding to cellular base station communication towers numbered A6-A20, which may correspond to a larger region of Manhattan. Although the bid amounts have been represented as being related as “X”, “X+Y”, and “X+Y+Z, it is to be understood that the bid amounts may be unrelated to one another and may be received as secret bids with one bidder not being aware of other pending bids.

Accordingly, although each of these website promoters “Bidder A”, “Bidder B”, “Bidder C”, and “Bidder D” have each bid on the same search term “Hotel”, they are bidding for advertising services to different geographic areas, although some of the geographic areas partially overlap. Moreover, the website promoters “Bidder A”, “Bidder B”, “Bidder C”, and “Bidder D” have bid different amounts for advertising services related to the search term “Hotel” and those different geographic areas.

In response to these bids, an Internet search engine can choose to award on-line advertisement placement services to each of these website promoters for the defined term and corresponding geographic areas. In response to receiving a search term query, the Internet search engine can select among the website promoters based on one or more queried terms (e.g., “Hotel”), the geographic region from which the query originated, and the amount bid by the website promoters.

By way of example, an Internet search engine may respond to a search term query containing the term “Hotel” and which originated from a wireless mobile terminal that is communicating with cellular tower A1 by displaying an advertisement for Bidder C and/or by listing that Bidder C's website among the search results which are returned to the wireless mobile terminal. Bidder C pays the Internet search engine the amount “X+Y+Z”, or another agreed-upon amount, for these on-line advertisement services. When the search term “Hotel” originates from cellular tower A6, the Internet search engine carries out advertisement services for Bidder D if the bid amount “W” exceeds the bid amount “X+Y+Z”, or otherwise carries out advertisement services for Bidder C. When the search term “Hotel” originates from New York city but not from cellular towers A1-A20, the Internet search engine advertises for Bidder B. Similarly when the search term “Hotel” originates from New York State, but not from New York city or cellular towers A1-A20, the Internet search engine advertises for Bidder A. Accordingly, the Internet search engine uses the search term “Hotel” to identify the advertisement sponsors who have been awarded rights to that search term. The Internet search engine further uses the associated geographic location where the search term query originated and the monetary amount of the associated bids to select which of those advertisement sponsors will be advertised in response to the search term query.

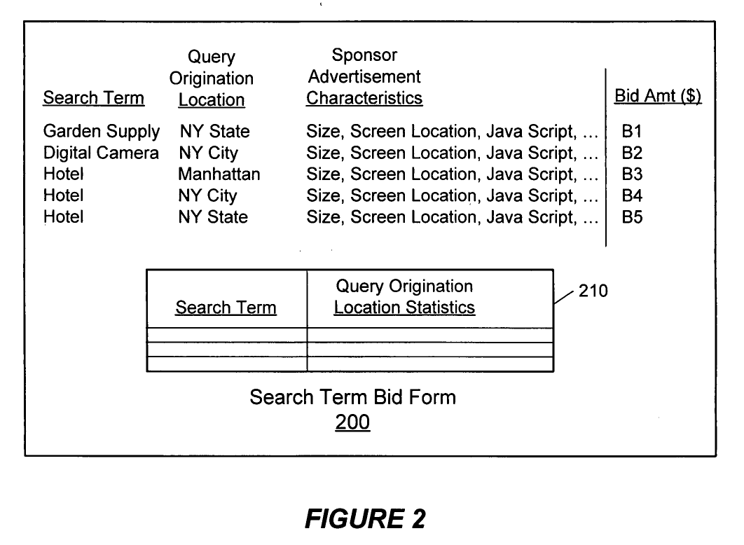

FIG. 2 is a table that illustrates an exemplary search term bid form 200 that may be generated by an Internet search engine to auction on-line advertisement services in accordance with some embodiments of the present invention. Website promoters may, for example, log onto an Internet search engine from remote computers to bid in an auction for on-line advertisement services. The Internet search engine may display the exemplary search term bid form 200 on the remote computers to solicit bids from the Website promoters. The search term bid form 200 includes input fields that are configured to receive information from bidders, including a search term(s), a corresponding geographic area(s), characteristics of the advertisement, and a corresponding monetary bid. For example, with reference to FIG. 2, a website promoter may bid different monetary amounts for the search term “Garden Supply” in a query that originates from somewhere in New York state, for the search term “Digital Camera” in a query that originates from somewhere in New York city, and for the search term “Hotel” in a query that originates from somewhere in Manhattan, New York city, and/or New York state. The website promoter's bid may also be based on additional characteristics of the solicited advertisement, such as the size and/or location of the advertisement that will be displayed on the remote querying computers and/or the audio/video characteristics of the advertisement, such as the size and/or data rate of the JavaScript or other executable instructions carried-out by the Internet search engine/remote computer to provide audio and/or video aspects of the sponsored advertisement.

The Internet search engine may further display a historical statistics table 210 on the search term bid form 200 that shows, for example, various statistics that have been generated for the rate at which different search terms have originated from defined geographic areas and/or the click-through rate at which advertisements displayed in those defined geographic areas have been selected by users. Accordingly, website promoters may obtain a sense of the potential value of particular search terms and associated geographic areas to the advertisement services that they are seeking when the website promoters are placing bids in the search term bid form 200.

The Internet search engine can then carry out the auction of its on-line advertisement services based on a comparison of the search terms, the associated geographic areas, and the monetary amount of the bid provided through the search term bid form 200 from each of the participating website promoters. When multiple competing bids are made from the same search term and same geographic area, the Internet search engine may award the corresponding advertisement placement service to the highest bidder, and may allow the lower bidders to continue to bid for that search term but for geographic areas that are different than that awarded to the highest bidder. In contrast, when multiple competing bids were made for the same search term but for different, but possibly partially overlapping, geographic areas, the Internet search engine may award the corresponding advertisement placement services to each of the competing bids. When a search term originates from a geographic area covered by more than one website promoter, the Internet search engine may select among those promoters based on the amount of their bids.

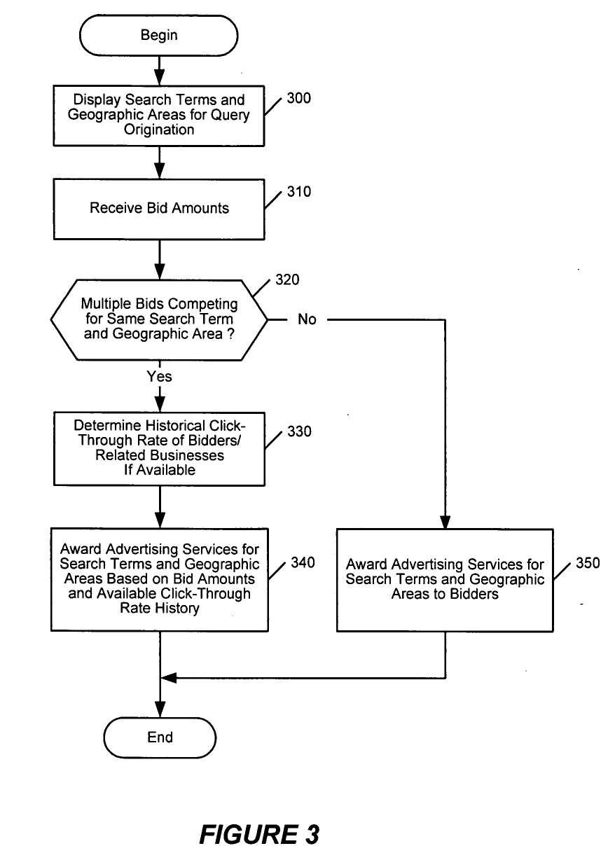

FIG. 3 is a flow chart that illustrates operations for auctioning on-line advertisement placement services for Internet search terms and associated geographic areas where the Internet search term queries will originate in accordance with some embodiments of the present invention. During the auction, an Internet search engine displays on the remote computers of the participating website promoters (Block 300) the offered search terms and corresponding geographic areas where the search term queries will originate. The Internet search engine receives the bid amount (Block 310) from the participating website promoters. The Internet search engine analyzes bids (Block 320) to determine whether multiple bids are competing for the same search term in the same geographic query origination area. When competing bids have occurred, the Internet search engine may attempt to identify (Block 330) historical information that Internet search engine may have gathered which is indicative of click-through rates for the bidders and/or related businesses that may be similar to that of bidders. Because the Internet search engine may be paid based on the number of times that users click-through sponsored advertisements to the sponsor's own website, the Internet search engine may evaluate such historical click-through rate information for the particular bidders and/or related businesses so as to more accurately forecast the potential revenue that may be obtained by awarding the advertisement services to one bidder over another bidder. The Internet search engine may award (Block 340) the advertisement placement services for the offered search terms and geographic query origination areas based on the bid amount and available click-through rates history. Alternatively, when competing bids are received, the Internet search engine may send the bid information to the bidders to offer another round of biding to those bidders for the same terms and/or geographic areas, and/or for related terms and/or geographic areas (such as new bidding for NY city if certain bidders lose the bidding for Manhattan).

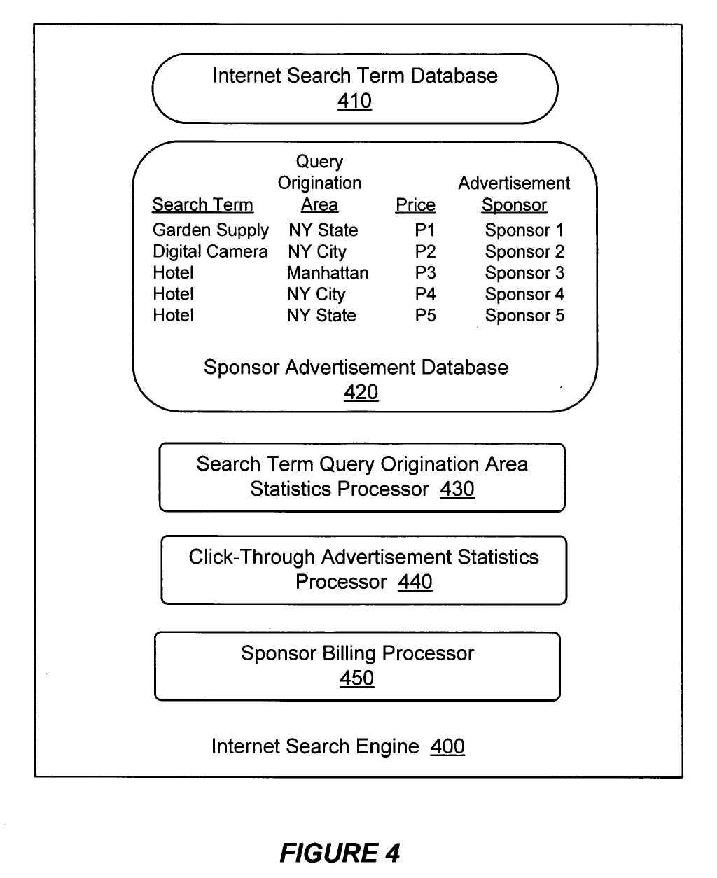

FIG. 4 is a block diagram of an Internet search engine 400 that is configured in accordance with some embodiments of the present invention. Referring to FIG. 4, the Internet search engine 400 may include an Internet search term database 410, a sponsor advertisement database 420, an origination location statistics processor 430, a click-through advertisement statistics processor 440, and a sponsor billing processor 450. The Internet search term database 410 may identify word terms and other searchable content of websites that has been previously gathered, and it may be configured in a well-known manner that is used in conventional Internet search engines.

The sponsor advertisement database 420 identifies advertisement sponsors who have been awarded certain search terms and corresponding geographic query origination areas for those search terms, and identifies the price that will be paid for those sponsored advertisements. Accordingly, the sponsor advertisement database 420 may be generated by selecting among website promoters who participated in the advertisement services auction by completing the search term bid form 200 of FIG. 2. The sponsor advertisement database 420 may be dynamically updated to allow website promoters to vary their bids for certain search terms and corresponding geographic areas in an attempt to outbid other competing website promoters. The sponsor billing processor 450 charges sponsors for the on-line advertisement placement services, and may charge sponsors for the number of times that users select sponsored advertisements to click-through to the sponsor's own website.

The statistics processor 430 generates statistics for how many times search terms have been received in historical search term queries and the geographic areas where those queries originated. The statistics processor 440 generates statistics on the rate at which users have selected a sponsor's advertisement and, thereby, have clicked-through an embedded hyperlink to the sponsor's own website. The statistics processor 430 and/or the statistics processor 440 may display the generated statistics in the historical statistics table 210 of the search term bid form 200 shown in FIG. 2. Accordingly, the Internet search engine 400 can generates statistics that can be used by Internet search engine 302 and/or by website promoters as part of their valuation of certain on-line advertisement services when participating in the auction for on-line advertisement services.

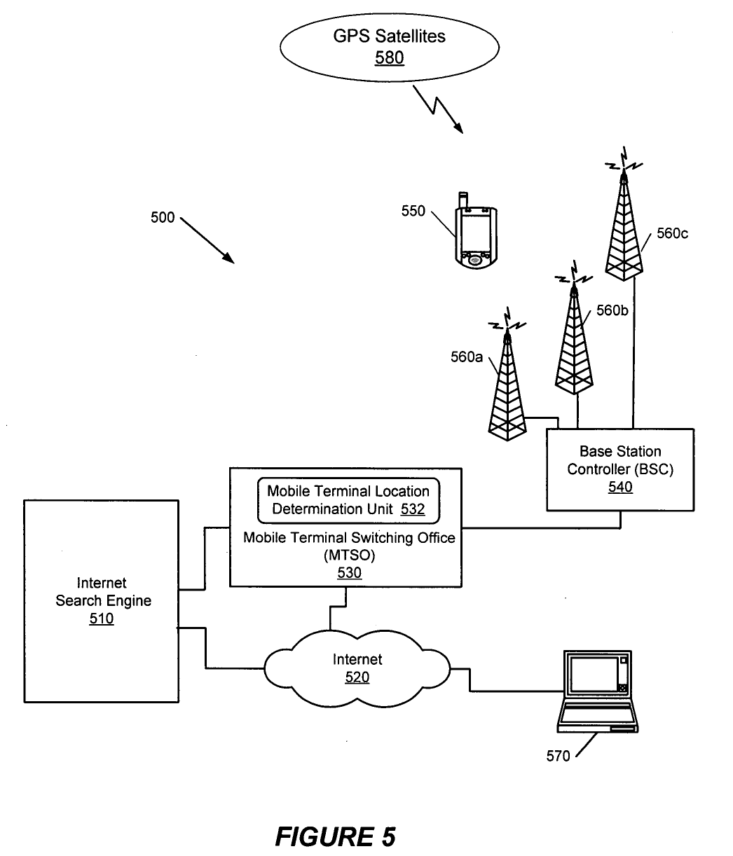

FIG. 5 is a block diagram of the communication system 500 that is configured to carry out auctioning of on-line advertisements and to display advertisements in response to Internet search terms and geographic query origination area in accordance with some embodiments of the present invention. Referring to FIG. 5, the system can include an Internet search engine 510, the Internet 520, a mobile terminal switching office (MTSO) 530, base station controller (BSC) 540, wireless mobile terminal 550, a plurality of wireless transceiver base stations 560a-c, and a personal computer 570, such as a laptop computer.

The mobile terminal 550 can communicate across a wireless interface with one or more of the wireless transceiver base stations 560a-c, and may communicate using one or more cellular communication protocols that can include, but are not limited to, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). As used herein, the term “mobile terminal” or “wireless terminal” may include a satellite or cellular radiotelephone; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop computer or other data processing device that is configured to communicate with an Internet search engine.

The base stations 560a-c can be controlled by the BSC 540 and the MTSO 530. The base stations 560a-c each have an associated geographic area over which they provide communication coverage to the mobile terminal 550, and the coverage areas of the base stations 560a-c may partially overlap. The BSC 540 may control hand-off of the mobile terminal 550 between the base stations 560a-c as the mobile terminal 550 moves across the various coverage areas. The MTSO routes communications between mobile terminal 550 via the BSC 540 and other BSCs, the Internet 420, the Internet search engine 410, and other networks. The MTSO 530, the BSC 540, and the base stations 560a-c accordingly form a wireless communication network.

The Internet search engine 510 may be configured as was described above with regard to the Internet search engine 400. The Internet search engine 510 receives search term queries from the mobile terminal 550 and from the personal computer 570. More particularly, a user may direct an Internet web browser hosted on the mobile terminal 550 or on the personal computer 570 to the website of the Internet search engine 510, and may then enter one or more search terms which are sent as a query via one or more data packets to the Internet search engine 510. The Internet search engine 510 also receives information that is indicative of the geographic area from which the search term query originated. This geographic origination area information may be generated by one or more of the components of the system 500, such as by the mobile terminal 550, the BSC 540, the MTSO 530, the Internet 520, and/or the personal computer 570.

For example, the mobile terminal 550 may be configured to determine its geographic location and to automatically provide that location (i.e., without requiring user intervention) to the Internet search engine 510 with a search term query, and may embed the determined geographic location within at least some of the same data packets that communication the search term query to the Internet search engine 510. The mobile terminal 550 may determine its location based on triangulation of signals that are received from a plurality of GPS satellites 580 and/or based on triangulation of signals that are received from the base stations 560a-c and/or other base stations.

The MTSO 530 may include a terminal location determination unit 432 configured to determine the location of the mobile terminal 550 based on triangulation of signals received by the base stations 560a-c from the mobile terminal 550. The MTSO may alternatively or additionally determine the location of the mobile terminal 550 using an identifier of one of the base stations 560a-c that is providing communications to the mobile terminal 550 (i.e., determine that the mobile terminal 550 is within a communication service area of a particular one of the base stations based on the base station identifier that the MTSO 530 receives from that base station). The MTSO 530 can then communicate the determined mobile terminal location to the Internet search engine 510. Accordingly, a wireless network operator of the MTSO 530 may determine the location of the mobile terminal 550 and provide that location to the Internet search engine 510, and may charge a fee for those services.

The Internet search engine 510 may determine the location of the mobile terminal 550 based on a routing area identifier that is received with a data packet transporting the search term query from the mobile terminal 550 and/or from the personal computer 570. The routing area identifier may be added by the MTSO 530 to data packets that are routed from the mobile terminal 550 to the Internet search engine 510 through private networks and/or the Internet 520. The routing area identifier may also be added by edge routers and/or other network routers within the Internet 520 to packet data communications from the personal computer 570 to the Internet search engine 510. The Internet search engine 510 may have knowledge of what routing area identifiers and assigned to what local Internet operators and knowledge of the geographic areas that are serviced by those local Internet operators. Accordingly, the Internet search engine 510 may determine from a received routing area identifier that an associated search term query originated from a defined geographic region, such as a geographic region associated with a particular MTSO, edge router, equipment operated by a local Internet operators, or another component of the system 500 having a known geographic location or geographic region that it services.

A user may register with the Internet search engine 510 to develop a user profile that includes information that identifies a geographic location of the user. The Internet search engine 510 may install a location cookie on the mobile terminal 550 and/or the personal computer 570 that contains information that identifies the user's registered geographic location. The terminal 550 and/or the computer 570 can communicate the location cookie to the Internet search engine 510 to identify its geographic location. The location cookie may be forwarded to the Internet search engine 510 in one or more data packets that also transport the search term query, or it may be retrieved from the terminal 550 and/or the computer 570 by the Internet search engine 510 in response to receiving the search term query from the user.

As described above, the Internet search engine 510 can use the geographic area where the search term query originated to select on-line advertisements and/or sponsored website addresses that are included with search results that the Internet search engine 510 communicates to the querying terminal 550 and/or computer 570. The Internet search engine 510 may determine from the location information the state, postal ZIP code, city, town, and/or other defined geographic areas where the search term query originated, and select among sponsor advertisements, such as those within the sponsor advertisement database 420, based on that determination.

Website promoters may also use the mobile terminal 550 and/or the personal computer 570 to complete the search term bid form 200 shown in FIG. 2 as described above to bid on search terms and associated geographic areas where the search terms will originate.

Although FIG. 1 illustrates an exemplary system 500 configured to carry out auctioning of on-line advertisements and to display advertisements in response to Internet search terms and geographic area from which they originated, it will be understood that the present invention is not limited to such a configuration but is intended to encompass any configuration capable of carrying out the operations described herein.

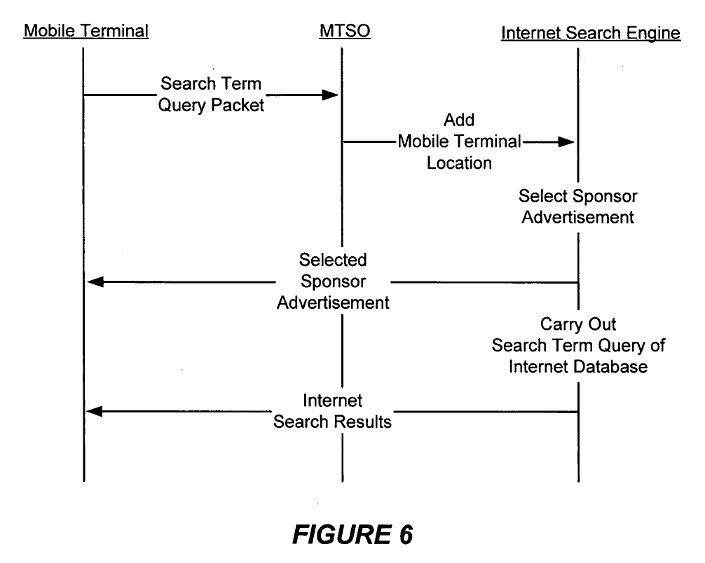

FIG. 6 is a message flow diagram that illustrates operations for displaying advertisements in response to Internet search term queries and in response to geographic areas where the queries originated. Referring to FIG. 6, the mobile terminal 550 sends a search term query data packet through the MTSO 530 to the Internet search engine 510. The MTSO 530 determines the location of the mobile terminal 550 and adds that location information to the search term query data packet. Alternatively, as described above, the mobile terminal 550 may determine its geographic location and communicate that location as part of the search term query data packet, and/or the Internet search engine 510 may determine a geographic area where the query originated. The Internet search engine 510 responds to the search term query data packet by selecting a sponsor advertisement based on one or more search terms and the geographic area where the query originated. The Internet search engine 510 communicates the selected sponsor advertisement through the MTSO 530 to the mobile terminal 550. The Internet search engine 510 carries out the search term query by searching website content, such as by searching the Internet search term database 410 shown in FIG. 4. The Internet search engine 510 communicates the search results to the mobile terminal 510, and may include a selected sponsor website among the search results.

In the drawings and specification, there have been disclosed exemplary embodiments of the invention. Although specific terms are used, they are used in a generic and descriptive sense only and not for purposes of limitation, the scope of the invention being defined by the following claims.

That which is claimed:

1. A method for auctioning on-line advertisement placement services, the method comprising:
offering an on-line advertisement placement service based on at least one search term and based on at least one geographic area where the at least one search term will originate;
receiving monetary bids from entities responsive to the offer of on-line advertisement placement service; and
in response to the monetary bids, awarding the on-line advertisement placement service for the at least one search term originating from the at least one geographic area to a selected one or more of the entities.

2. The method of claim 1, further comprising:
receiving from a user via a network a search term query to be searched using an Internet search engine; and
transmitting via the network an advertisement associated with the selected entity to the user in response to the search term query containing a search term corresponding to the at least one search term and originating from the at least one geographic area awarded to the selected entity.

3. The method of claim 2, further comprising:
offering the on-line advertisement placement service based on the at least one search term and based on at least one postal zip code from which the at least one search term will originate; and
determining a postal zip code for the geographic area where the search term query originated; and
transmitting via the network an advertisement associated with the selected entity to the user in response to the search term query containing a search term corresponding to the at least one search term and originating from a postal zip code area awarded to the selected entity.

4. The method of claim 2, further comprising:
offering the on-line advertisement placement service based on the at least one search term and based on at least one town, city, and/or state where the at least one search term will originate; and
determining a town, city, and/or state where the search term query originated; and
transmitting via the network an advertisement associated with the selected entity to the user in response to the search term query containing a search term corresponding to the at least one search term and originating from a town, city, and/or state area awarded to the selected entity.

5. The method of claim 2, further comprising:
identifying a routing area identifier received with a network data packet carrying at least a portion of the search term query; and
determining the geographic area where the search term query originated in response to the routing area identifier.

6. The method of claim 1, further comprising:
receiving from a wireless mobile terminal, via a wireless transceiver base station of a wireless communication network, a search term query to be searched using an Internet search engine;
determining a geographic area where the search term query originated in response to an identifier of the wireless transceiver base station; and
transmitting an advertisement associated with the selected entity to the wireless mobile terminal, via the wireless transceiver base station of the wireless communication network, in response to the search term query containing a search term corresponding to the at least one search term and originating from a geographic area awarded to the selected entity.

7. The method of claim 6, wherein determining a geographic area where the search term query originated in response to an identifier of the wireless transceiver base station is carried out within the wireless communication network, and further comprising:
communicating the search term query and the determined geographic area from the wireless communication network to the Internet search engine; and
carrying out at the Internet search engine the transmitting an advertisement associated with the selected entity to the wireless mobile terminal.

8. The method of claim 1, further comprising:
receiving from a wireless mobile terminal, via a wireless transceiver base station of a wireless communication network, a search term query to be searched using an Internet search engine;
determining a geographic area of the wireless mobile terminal where the search term query originated by triangulation of communication signals received by a plurality of wireless transceiver base stations of the wireless communication network from the wireless mobile terminal; and
transmitting an advertisement associated with the selected entity to the wireless mobile terminal, via the wireless transceiver base station of the wireless communication network, in response to the search term query containing a search term corresponding to the at least one search term and originating from a geographic area awarded to the selected entity.

9. The method of claim 1, further comprising:
determining a geographic location of a wireless mobile terminal based on triangulation of signals received from a plurality of satellites;
receiving from the wireless mobile terminal, via a wireless transceiver base station of a wireless communication network, a search term query to be searched using an Internet search engine and the determined geographic location of the wireless mobile terminal; and
transmitting an advertisement associated with the selected entity to the user, via the wireless transceiver base station of the wireless medication network, in response to the search term query containing a search term corresponding to the at least one search term and originating from within a geographic area awarded to the selected entity.

10. The method of claim 1, further comprising:
registering a user with an Internet search engine and receiving therethrough geographic location information associated with the user;
receiving at the Internet search engine, via a network, a search term query from the user to be searched using the Internet search engine; and
communicating an advertisement associated with the selected entity to the user, via the network, in response to the search term query containing a search term corresponding to the at least one search term and originating from within a geographic area awarded to the selected entity.

11. The method of claim 10, further comprising:
storing a location cookie containing the geographic location information of the user on a mobile terminal operated by the user; and
retrieving the location cookie from the mobile terminal in response to the Internet search engine receiving the search term query from the communication terminal.

12. The method of claim 10, further comprising:
storing a location cookie containing the geographic location information of the user on a mobile terminal operated by the user; and
communicating the location cookie with the search term query from the mobile terminal to the Internet search engine.

13. The method of claim 1, further comprising:
generating click-through rate statistics for advertisements provided to users located within at least one defined geographic area; and
based on the monetary bids and based on the click-through rate statistics, awarding the on-line advertisement placement service for the at least one search term originating from the at least one geographic area to a selected one of the entities.

14. The method of claim 11, further comprising:
displaying the click-through rate statistics to entities when offering the on-line advertisement placement service for the at least one geographic area.

15. The method of claim 1, further comprising:
generating origination location statistics that are indicative of how many defined search terms have originated from defined geographic areas.

16. The method of claim 15, further comprising:
displaying the origination location statistics to entities when offering the on-line advertisement placement service for the at least one search term.

17. A computer program product of claim 1 for auctioning on-line advertisement placement services, the computer program product comprising:
a computer readable storage medium having computer readable program code embodied therein configured to carry out the method of claim 1.

18. A method for auctioning on-line advertisement placement services, the method comprising:
displaying input fields on a plurality of remote computers;
receiving information from bidders at the remote computers in response to the input fields that includes at least one search term, a corresponding at least one geographic area where the at least one search term will originate, and a corresponding monetary bid; and
communicating the information from the remote computers to an Internet search engine.

19. The method of claim 18, further comprising:
receiving the information at the Internet search engine from the remote computers; and
in response to the monetary bids, awarding the on-line advertisement placement service for the at least one search term originating from the at least one geographic area to a selected one or more of the entities.

20. A method for auctioning on-line advertisement placement services, the method comprising:
receiving at an Internet search engine, from a user via a network, a search term query to be searched using the Internet search engine and location information that is indicative of a least one geographic area where the at least one search term originated;
selecting an advertisement in response to the search term query and the geographic area where the at least one search term originated; and
transmitting via the network the selected advertisement to the user.
